(19) United States
(12) Patent Application Publication
(10) Pub. No.: US 2023/0235627 A1
(43) Pub. Date: Jul. 27, 2023

(54) A COUPLING DEVICE FOR A LADDER

(71) Applicant: Branach Technology Pty Ltd, Boronia, Victoria (AU)

(72) Inventor: Michael Walsh, Heathmont, Victoria (AU)

(21) Appl. No.: 18/001,907

(22) PCT Filed: Jun. 15, 2021
(86) PCT No.: PCT/AU2021/050613

§ 371 Date: Dec. 15, 2022

(30) Foreign Application Priority Data
Jun. 15, 2020 (AU) 2020901961

(51) Int. Cl. E06C 7/50; E06C 7/46; E06C 7/12; E06C 7/48

(52) U.S. Cl. CPC E06C 7/50; E06C 7/46; E06C 7/12; E06C 7/48

(57) ABSTRACT

The invention provides a coupling device (1), for a ladder having a bore in a headstock (4) extending between a pair of spaced apart styles, the coupling device (1) comprising: an elongate support member (6) having a mounting region (8) and a working region (7), the mounting region (8) configured to be received within the bore of the ladder to engage therewith, the working region (7) being configured to protrude from the bore and to receive and support a plurality of utility modules; and a releasable detent (9) to secure the elongate support member (6) within the bore, wherein the mounting region (8) is restrained from rotational movement relative to the bore, and the releasable detent (9) prevents longitudinal and transverse movement between the elongate support member (6) and the bore. The coupling device (1) of the invention provides a flexible ladder assembly that is adaptable to variable work environments encountered at the top of a portable ladder when used for access and conducting work.

### TECHNICAL FIELD

This invention relates to a coupling device for a ladder and a number of utility modules that can be coupled to the ladder via the coupling device, in situ.

### BACKGROUND

Ladders and extendable platforms have long been used to provide access to elevated work places; however, they pose a serious safety risk and account for numerous injuries worldwide every year to both tradespeople and the general populous.

Typical injuries caused by ladders and work platforms range from slips and falls from people losing their balance whilst on ladders or raised platforms, to destabilising of the ladder/platform when it is placed on an uneven or slippery surface.

A further issue is the accommodation of tools or required materials once at the elevated work site, as the user must ascend the ladder with such necessary items, further detracting from the user's safety when ascending and descending.

The following invention was conceived with the aforementioned shortcomings in mind.

### SUMMARY OF THE INVENTION

In accordance with a first aspect of the invention, there is provided a coupling device, for a ladder having a bore extending between a pair of spaced apart styles, the coupling device comprising: an elongate support member having a mounting region and a working region, the mounting region configured to be received within the bore of the ladder to engage thereto, and the working region being configured to protrude from the bore and to receive and support one or a plurality of utility modules; and a releasable detent to secure the elongate support member within the bore, wherein the mounting region is restrained from rotational movement relative to the bore, and the releasable detent prevents longitudinal movement of the elongate support member relative to the bore.

The coupling device provides the ability to couple the ladder with one or more utility modules forming a ladder assembly.

An advantage of the invention is that the ladder can be modified, in situ, to provide a plurality of additional functional features to aid a user in working at an elevated work zone. The utility modules may also provide safety benefits to reduce the opportunity for injury at, and en route to, the elevated work zone.

The coupling device of the invention provides a flexible ladder assembly that is adaptable to variable work environments encountered at the top of a portable ladder when used for access and conducting work. The user with just a few basic modular pieces can adapt the ladder assembly to most geometries encountered including vertical walls, horizontal platforms, roofs of various inclinations all of which may be at varying levels or uneven. The flexible ladder assembly may be used to span windows or openings in these surfaces affording a leaning surface that was not apparent without the ladder assembly.

Furthermore, the coupling device when suitably designed with appropriate strength can provide temporary access to roofs and platforms affording the user fall protection whilst transitioning and working in these elevated work areas. Risks such as falling over the edge or through a roof whilst conducting work may be mitigated or at least reduced, with the ladder assembly adapted in this way.

The ladder assembly contains basic building blocks which may be adapted to forming work platforms, conveyancing of materials or other uses that that the user finds desirable for conducting work.

In some embodiments, the elongate support member may comprise two parts, a first portion and separate a second portion, each portion configured to provide a mounting region and a working region, such that the working regions of each of the first portion and the second portion protrude from the bore with the mounting regions located within opposing ends of the bore of the ladder.

In some embodiments, the elongate support member may comprise a single beam having the mounting region centrally located along the beam and working regions located at opposing ends of the beam, such that the working regions protrude from the bore of the ladder when the elongate support member is mounted thereto.

The mounting end of the or each elongate support member may be axially splined to prevent rotation relative to the bore.

The working end of the or each elongate support member may be splined or keyed to receive one or more non-rotatable connectors thereabouts. The working end of the or each elongate support member may be provided with a secondary detent for preventing the one or more rotatable connectors from becoming detached from the elongate support member.

In some embodiments, the elongate support member may have a quadrilateral cross-section. Alternatively, the elongate support member may have a square in cross-section. In some embodiments, the bore may be internally splined to receive the axial splines of the elongate support member and thereby prevent rotational movement therebetween.

The detent and the secondary detent may be selected from the following group: a bolt, a pin, a spring-loaded stopper, a bolt spring plunger and a snap-lock plunger. As such, the coupling device facilitates a tool free engagement and release of a utility module with the ladder. The coupling device is securely attached to the ladder and can be quickly released for transport and erection of the ladder assembly.

In some embodiments, a first of the plurality of utility modules may comprise a pair of adjustable legs for supporting the ladder on a vertical or a horizontal surface.

Each leg may comprise a plurality of equidistantly spaced holes for releasably engaging an adjustable connector. The adjustable connector may comprise two pieces: a connecting cuff and a releasable collar. The cuff may at least partially encircle the leg. The cuff may provide a locking means, to releasably secure the cuff to one of the plurality of holes along the leg. Each leg may have an articulating foot to provide planar contact with a supporting substrate to the ladder. Each leg may further provide a non-slip foot or base to improve friction with the support surface.

The cuff may be adjustably mountable to collar. The collar may provide a plurality of mounting apertures for engaging with the cuff. The collar may be hollow and shaped to fully or partially encircle the elongate support member of the coupling device.

The collar may be internally splined to facilitate mounting of the collar in a plurality of defined orientations about the elongate support member. The collar may provide twelve internal splines spaced at 30-degree angles to one another, facilitating a connection between the collar and the elongate support member in twelve distinct orientations.

In some embodiments, a second of the plurality of utility modules may comprise an armature for counterbalancing the weight of a user on the ladder and stabilising the ladder. The armature may be configured as a davit arm.

The armature may comprise two converging uprights rigidly attached to the elongate support member. In some embodiments, the first and the second uprights are separately attached to corresponding first and second portions of the elongate support member. The converging ends of the two uprights may be constrained to one another at an apex. The apex may provide a closable mount. The closable mount may be configured to receive and retain a static line or an arrest rope therein, the arrest rope being attached directly or indirectly to a user ascending the ladder.

In some embodiments, the arrest rope is engageable with a fall control system mounted to the ladder, to arrest a user's descent.

The apex may provide an aperture for tethering the armature to a fixed structure or tether point for the ladder.

An inclination angle of the uprights of the armature may be determinative of a load transferred down styles of the ladder when a user's weight is applied to the closable mount via the tether chord.

A harness may be permanently engaged between the user and the armature to provide a working anchor point for the user at the elevated work zone.

In some embodiments, a third of the plurality of utility modules may comprise a combination of the pair of adjustable legs and the armature described herein.

A first and a second cuff may be mounted to a respective first and second leg, wherein the first and second cuffs are respectively affixed to a first and a second collar, and the first and second collars may be mounted respectively to the first and the second portions of the elongate support member to which the uprights of the armature are rigidly attached.

In some embodiments, a fourth of the plurality of utility modules may comprise a winch system for winching items to the upper working level of the ladder.

The winch system may comprise a winching arm, having a first end and a second end. The first end of the winching arm may be mountable to the elongate support member via the cuff and collar.

The second end of the winching arm may provide a cable brake for controlling the travel of a winch cable therethrough.

The cable brake may provide a cable guide and a plurality of teeth for trapping and holding the cable when pulled in a first direction only. The plurality of teeth may be configured to release the winch cable when pulled in a second direction, the second direction opposing the first direction. The fourth utility module may be used in conjunction with the adjustable legs of the first utility module as well as other utility modules.

In some embodiments, a fifth of the plurality of utility modules may comprise a pole tether for securing a user to the top portion of the ladder to provide hand-free working.

The pole tether may be mounted to the coupling device by a pair of side arms, the side arms rigidly connected to the first and second portions of the elongate support member. The side arms may extend outwardly from both the bore of the ladder and from the styles of the ladder.

The two side arms may be interconnected by the pole tether. The pole tether may be a flexible member that is arcuate, to allow the flexible member in combination with the ladder to encircle a cylindrical tether structure. For example, a telegraph pole, or pylon.

The flexible member may comprise at least one of a belt, a robe, a chain, a cable and a cord. A length of the flexible member may be adjustable. The length of the flexible member may be fixed.

In some embodiments, a sixth of the plurality of utility modules may comprise a pair of adjustable rails for assisting a user transitioning from the ladder to an elevated working zone.

The pair of adjustable rails may each comprise an internally splined collar to engage with the elongate support member at any one of twelve discrete mounting orientations. The collar may be an integrated part of the adjustable rail. The collar may be detachable from each of the adjustable rails. The adjustable rails of the sixth utility module may be used in conjunction with the adjustable legs of the first utility module as well as other utility modules.

In some embodiments, a seventh of the plurality of utility modules may comprise a horizontal platform for supporting a user at the top of the ladder or providing a horizontal working surface at the top of the ladder.

The horizontal platform may comprise a tray. The tray may be supported by the pair of adjustable legs in accordance with the first of the plurality of utility modules.

The tray may be additionally supported by a cross-beam that releasably mounts to each of the pair of adjustable legs. The cross-beam may provide a hoist. The hoist may comprise a hoist cable and a cable brake for controlling the movement of the hoist cable about the cross-beam. The cable brake may support the hoist cable for raising and lowering an off-centre bracket, for hoisting equipment to the top of the ladder.

In some embodiments, an eighth of the plurality of utility modules may comprise a combination of the pair of the adjustable rails and the horizontal platform as described herein.

In a further aspect, the invention provides a kit comprising the coupling device, as described herein, and a head stock for a ladder, the headstock having a bore extending at least partially therethrough for receiving the elongate support member of the coupling device.

To further facilitate transport and set-up of the ladder assembly, the ladder and the components of the utility modules are made from a lightweight durable material for example, aluminium or fibreglass.

In yet another aspect, the invention provides a ladder accessory for a ladder having a bore extending between a pair of spaced apart styles, the ladder accessory comprising a coupling device as described above, in combination with one or more of the above described utility modules.

In yet another aspect, the invention provides a ladder assembly comprising a ladder having a bore extending between a pair of spaced apart styles, a coupling device as described above in combination with one or more of the above described utility modules.

Various features, aspects, and advantages of the invention will become more apparent from the following description of embodiments of the invention, along with the accompanying drawings in which like numerals represent like components.

### BRIEF DESCRIPTION OF THE DRAWINGS

Embodiments of the invention will now be described in further detail below, wherein like reference numerals indicate similar parts throughout the several views. Embodiments are illustrated by way of example, and not by way of limitation, with reference to the accompanying drawings, in which:

FIG. 1A shows a perspective view of a ladder assembly coupled to a utility module via a coupling device according to according to an embodiment of the invention;

FIG. 1B is an enlarged view of the utility module and coupling device of FIG. 1A. illustrating the coupling device and utility module fitted to a headstock of the ladder;

FIG. 2A is a top perspective view of the headstock of FIG. 1A, illustrating a bore for receiving a coupling device according to one embodiment of the invention;

FIG. 2B is a bottom perspective view of the headstock and ladder of FIG. 2A;

FIG. 3A is a perspective view of the coupling device of FIG. 1A, illustrating a support member of the coupling device, for inserting into the bore of the headstock;

FIG. 3B is a perspective view of a support leg being mounted to the coupling device of FIG. 3A;

FIG. 3C is an end view of the support leg positioned and mounted to the coupling device, illustrating a detent within the support member for securing the support leg to the support member;

FIG. 4A is a perspective view of a first utility module comprising a pair of adjustable legs, fitted to support the extendable platform against a fixed structure;

FIG. 4B is a perspective view of an adjustable leg and a connecting cuff for mounting the leg to the coupling device;

FIG. 5A is a perspective view of a ring connector and the connecting cuff of FIG. 4B, illustrating a plurality of mounting apertures which releasably secure the cuff to the ring connector;

FIG. 5B is a perspective view of the ring connector affixed to the connecting cuff of FIG. 5A, illustrating a splined internal surface of the ring connector;

FIG. 5C is a perspective view of the ring connector fitted to the connecting cuff of FIGS. 5A and 5B, illustrating a locking means of the connecting cuff;

FIG. 6A is a perspective view of a second utility module comprising a pair of uprights forming a davit arm;

FIG. 6B is a perspective view of the headstock of the ladder aligned to receive a first support member of the second utility module of FIG. 6A;

FIG. 6C is a perspective view of the davit arm of the second utility module fitted to the headstock of the ladder;

FIG. 7A illustrates an arrest rope being fitted to the davit arm of FIG. 6A via a closable hook at an apex of the davit arm;

FIG. 7B is an enlarged view of FIG. 7A, of the closable hook encapsulating the arrest rope to the davit arm;

FIG. 8A illustrates components of a third utility module, comprising the components of the first and second utility modules in combination;

FIG. 8B is a perspective view of the ladder coupled to the third utility module, illustrating the adjustable legs and davit arm mounted via a single coupling device to a headstock of the ladder;

FIG. 9A illustrates a first step of connecting the third utility module to a ladder, wherein a first of the pair of adjustable legs are fitted to onto an end of the support member of the coupling device;

FIG. 9B illustrates a second step of connecting the third utility module to a ladder, in which the davit arm and adjustable leg are secured in place on the support member of the coupling device;

FIG. 9C illustrates a third step of connecting the third utility module to a ladder, wherein the arrest rope is attached to the apex of the davit arm;

FIG. 9D is a perspective view of a user, attaching themselves to the arrest rope of the ladder assembly, prior to ascending the ladder assembly;

FIG. 10A illustrates a user attached via a harness and lanyard to the davit arm of the ladder assembly;

FIG. 10B illustrates a user kneeling down in the harness of FIG. 10A while being tethered to the ladder assembly at an elevated working zone;

FIG. 11A illustrates components of a hoist module for use with the coupling device of the invention, providing a storage container to hold the hoist module;

FIG. 11B illustrates the hoist module fitted to the support member of the coupling device according to an embodiment of the invention;

FIG. 12A is a perspective view of a further utility module, illustrating a pole tether assembly partly fitted to the headstock of the ladder;

FIG. 12B is a top perspective view of the pole tether assembly of FIG. 12A fitted to the headstock of the ladder in an operative position;

FIG. 12C is a perspective view of the pole tether assembly of FIGS. 12A, illustrating the pole tether in a stowed position;

FIG. 13A illustrates the components of a further utility module, including a pair of adjustable hand rails and a work platform for providing a working surface on the top of the platform;

FIG. 13B is perspective view of a ladder assembly comprising the hand rails and work platform mounted to a ladder using the coupling device according to one embodiment of the invention;

FIG. 14A is a perspective view of a tool box attached to a hoist bracket and hoist mounted to the ladder with the coupling device of an embodiment of the invention; and

FIG. 14B is a perspective view of a user working from the work platform and hand rails of the utility modules mounted to the ladder using the coupling device according to one embodiment of the invention.

### DETAILED DESCRIPTION OF EMBODIMENTS

The invention will now be described more fully hereinafter with reference to the accompanying drawings. The invention may be embodied in many different forms and should not be construed as being limited to the embodiments described below.

The term “ladder” is understood herein to refer to a single or multi-piece fly ladder and to also include work platforms and hoists for supporting a user above the ground.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

While the invention is described herein in relation to an extendable ladder, it is understood that extendable work platforms and similar raised platforms are also contemplated to lie within the disclosure of the invention.

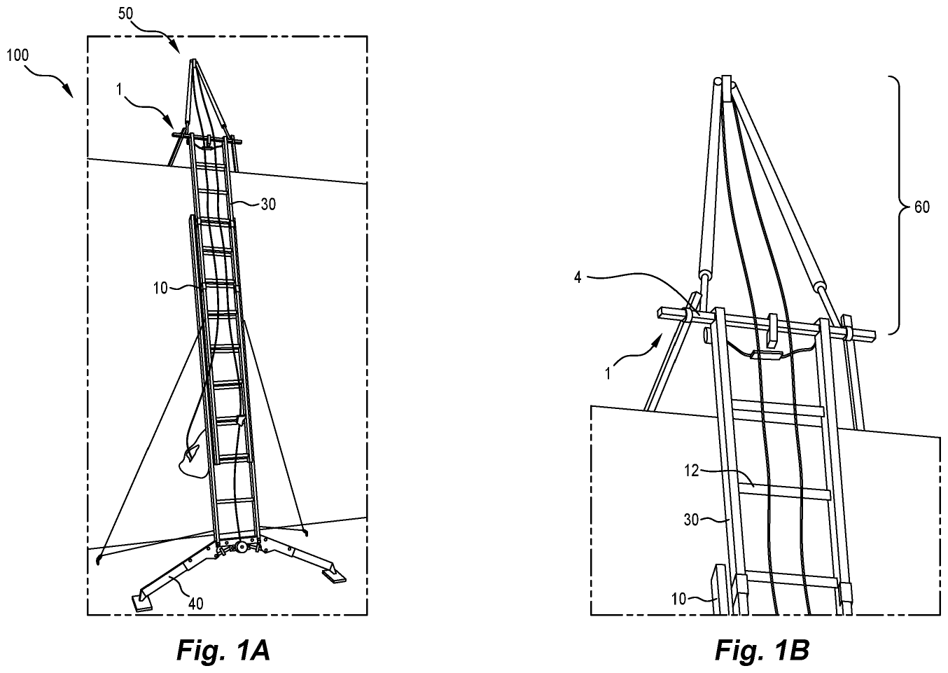

Illustrated in FIGS. 1A-14B is a coupling device and a plurality of utility modules for coupling to a ladder. The ladder provides a bore 2 extending between a pair of spaced apart styles 11.

The bore 2 can be formed in a headstock 4 of the ladder 3. The headstock 4 can be a fixed headstock or a removable headstock. The fixed headstock 4 is formed as an upper portion of the ladder 3. The removable headstock 4 is formed separately from the support section 10 of the ladder 3 and can be retrofitted to existing ladder stiles 11.

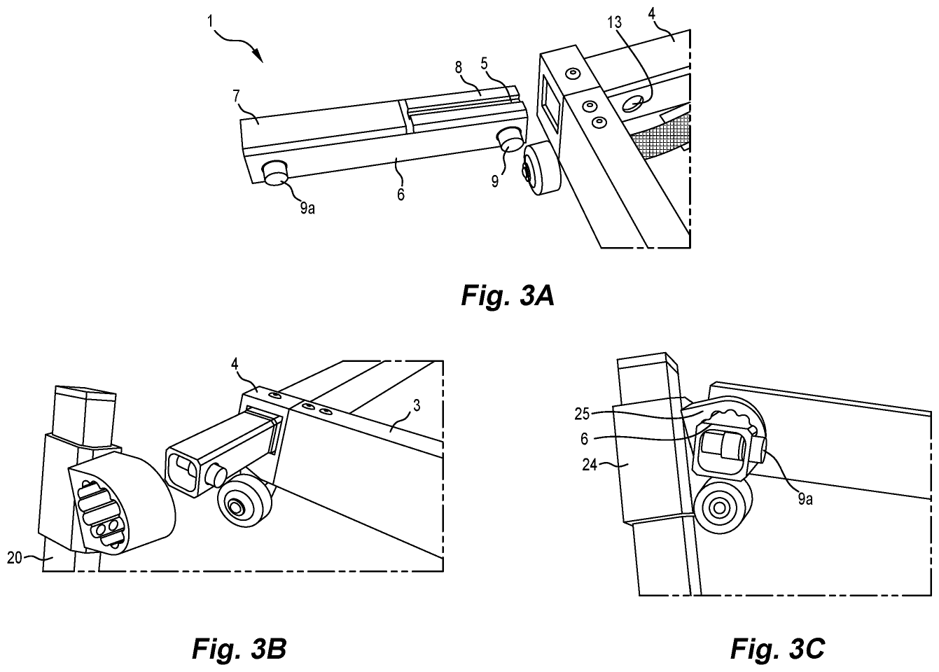

Illustrated in FIG. 3A, a coupling device 1, for a ladder 3 having a bore 2 extending between a pair of spaced apart styles, the coupling device 1 comprising: an elongate support member 6 having a mounting region 8 and a working region 7, the mounting region 8 configured to be received within the bore 2 of the ladder 3 to engage thereto, and the working region 7 being configured to protrude from the bore 2 and to receive and support a plurality of utility modules 60; and a releasable detent 9 to secure the elongate support member 6 within the bore 2, wherein the mounting region 8 is restrained from rotational movement relative to the bore 2, and the releasable detent 9 prevents longitudinal movement of the elongate support member 6 relative to the bore 2.

Illustrated in FIGS. 3A-3B, the elongate support member 6 is restrained from rotation within the bore 2 by virtue of the cross-sectional geometry of the elongate support member 6.

Shown herein, the bore 2 has a quadrilateral cross-section, and the elongate support member 6 also has a quadrilateral cross-section. In some embodiments the elongate support member 6 can have a square cross-section.

Alternatively, or additionally, the elongate support member 6 can be splined to rotationally lock the elongate support member 6 within the bore 2. Splines 5 can be confined to the mounting region 8 of the elongate support member 6 or extended from the mounting region 8 to the working region 7. The splines 5 will further provide a guiding means when engaging the elongate support member with the bore 2 of the headstock 4.

In some embodiments the ladder 3 is a single piece ladder. In some embodiments the ladder 3 is a fly ladder having a first support section 10, a second movable section 30 and in some embodiments a third removable section 40. The third removable section 40 can comprise a stabilising base permanently or removably attached to the support section 10 to broaden the base of the ladder 3.

In preferred embodiments of the invention the elongate support member 6 is dimensioned to provide a snug fit within the bore 2. As will be appreciated by the skilled person, eliminating movement between the detachable fitting to the ladder 3 can improve stability and therefore, safety of the resulting assembly 100.

FIGS. 1A and 1B show the coupling device 1 engaged with the bore 2 of the ladder 3, with a utility module 60 supported by the elongate support member 6. In this embodiment, the elongate member 6 is a beam. The elongate member 6 has a mounting region 8 and a working region 7. The mounting region 8 is the portion of the elongate member 6 that is received within the bore 2 of the headstock 4. The working region 7 is the portion of the elongate member 6 which provides an attachment zone for each of the plurality of utility modules 60. The mounting region 8 and the working region 7 are disposed at opposing ends of the elongate support member 6 as shown in FIG. 3A. When engaged with the headstock 4 of the ladder 3, the working region 7 protrudes from the bore 2. A pair of elongate support members 6 are used to engage utility modules 60 to each side of the ladder 3, to maintain balance to the ladder assembly 100.

Although not illustrated, it is contemplated that the elongate support member 6 can be formed from a single bar that extends entirely through the bore 2. In a single bar configuration, the elongate support member 6 has a central mounting region 8, and two working regions 7, the working regions 7 positioned at opposing ends of the elongate support member 6. When engaged with the headstock 4, the mounting region 8 is housed within the bore 2, and the working regions 7 protrude from opposing sides of the bore 2.

The elongate support member 6 can be formed as a solid bar, or as a hollow section or extrusion. The hollow elongate support member 6 provides opportunities for weight reduction of the ladder assembly 100. The hollow elongate support member 6 also provides clean mounting locations for one or more detents 9. Mounting the detent 9 within the elongate support member 6 reduces the opportunity for the detent 9 to protrude from the ladder 3, which in turn reduces the possibility of a user knocking or detaching the detent 9 when the ladder 3 is in use.

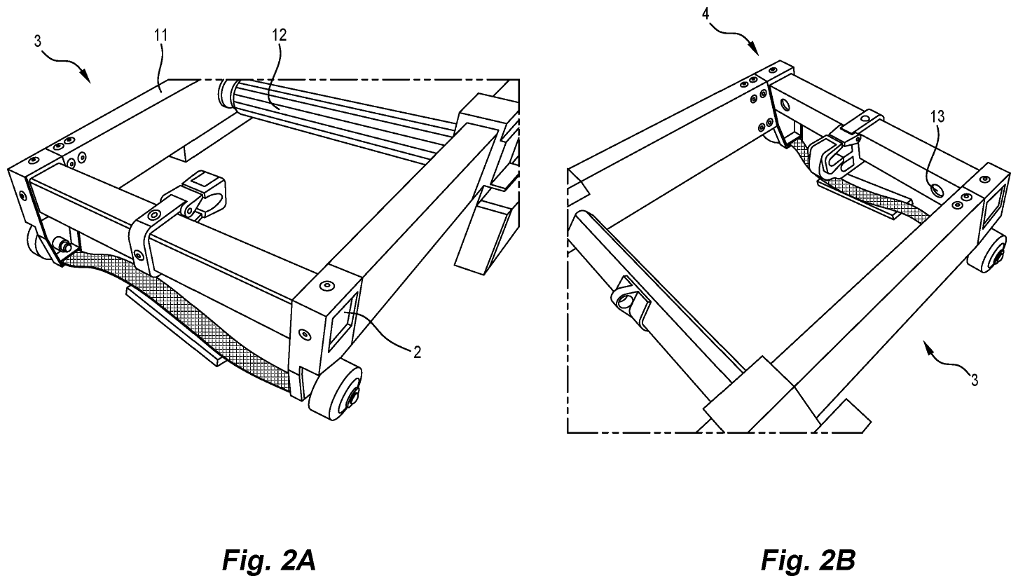

As illustrated in FIGS. 2A and 2B, the bore 2 within the headstock 4 of the ladder 3 has a complimentary geometry to the cross-section of the mounting region 8, such that mounting region 8 of the elongate member 6 can be received within the bore 2. The bore 2 can be configured continuously to extend through both stiles 11 of the ladder 3 and thereby provide a continuous passage through the ladder 3. In other embodiments, a pair of bores 2 are formed on opposing sides of the ladder 3 to each receive a respective elongate support member 6 that only partially extends into the headstock 4 of the ladder 3.

FIGS. 3A-3C illustrate a process of engaging the coupling device 1 to the headstock 4 of the ladder 3; and further coupling a utility module 60 to the coupling device 1.

The mounting region 8 of FIG. 3A has a square cross-section. As such, when received within the bore 2, the elongate member 6 is restrained from rotational movement relative to the ladder 3. Additionally, the mounting end 8 is axially splined, such that the connection between the elongate member 6 to the bore 2 is a keyed connection. As shown, the cross-section of the elongate support member 6 is substantially consistent along its axial length; however, it is understood that the working region 7 can have different cross-sectional dimensions to the mounting region 8. The working region 8 can also be axially splined or keyed, such that a utility module 60 can be connected thereto in a non-rotational manner.

As further illustrated in FIGS. 3A-3C, a first releasable detent 9 is disposed within the mounting region 8 of the elongate support member 6. The detent 9 engages with a corresponding aperture 13 disposed along the bore 2 of the headstock 4 to releasably secure the elongate support member 6 within the bore 2. In this manner the detent 9 prevents longitudinal movement between the elongate support 6 and the bore 2.

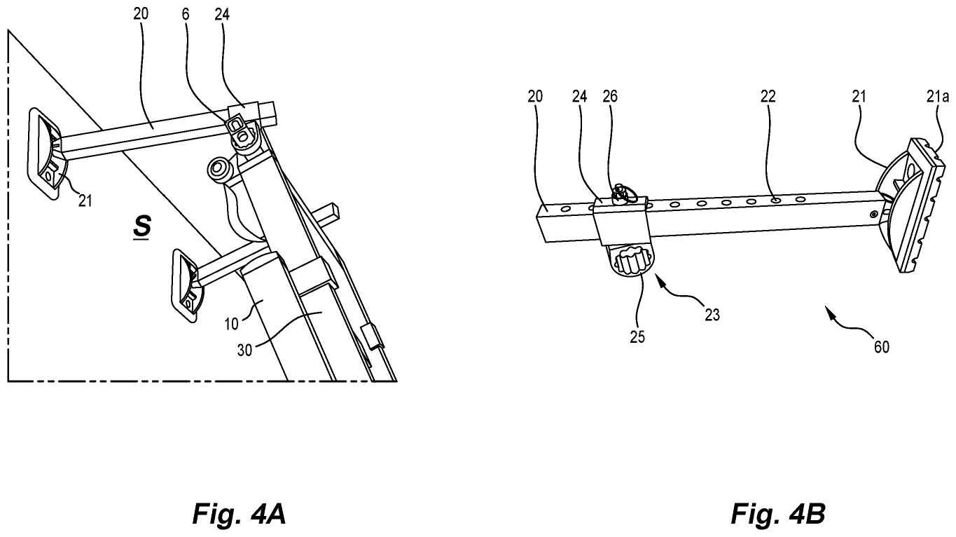

FIG. 3B illustrates a support leg 20 being mounted to the working region 7 of the elongate support member 6 via an adjustable connector. This mounting will be discussed further in relation to a first utility module 60 shown in FIGS. 4A and 4B.

As shown in FIG. 3A, the detent 9 comprises two portions biased against one another. The detent 9 can be spring loaded, such that the detent 9 is compressed by a user to insert the mounting region 8 of the elongate support member into the bore 2 and when the detent 9 aligns with the aperture 13, the detent 9 will decompress, such that a first portion of the detent 9 extends through the aperture 13, thereby locking the elongate support member 6 within the bore 2.

The protruding portion of the detent 9 can be brightly coloured to provide a visual indication that the elongate support member 6 is secured within the bore 2.

The aperture 13 is arranged along the bore 2, such that the detent 9 protrudes inwardly of the ladder assembly 100, to reduce the opportunity for snagging or catching the detent 9, when the ladder 3 is in use.

The detent 9 can be selected from any one of the following: a bolt, a pin, a spring-loaded stopper, a bolt spring plunger and a snap-lock plunger. However, it is contemplated that other variations of detent 9 can be used, for example such as a bolt, a pin, a nut and bolt or screwed fixing.

In some embodiments, a secondary detent 9a is disposed within the working region 7 of the elongate support member 6. The secondary detent 9a located towards an end of the elongate support member distal to the bore 2, to releasably secure one or more of the utility modules 60 onto the working region 7.

### First Utility Module: Support Legs

FIGS. 4A and 4B illustrate a first utility module 60 comprising a pair of adjustable legs 20, which when mounted to ladder 3 via the coupling device 1, provide either a horizontal stand-off or a vertical stand-off to position the ladder assembly 100 relative to a supporting structure S.

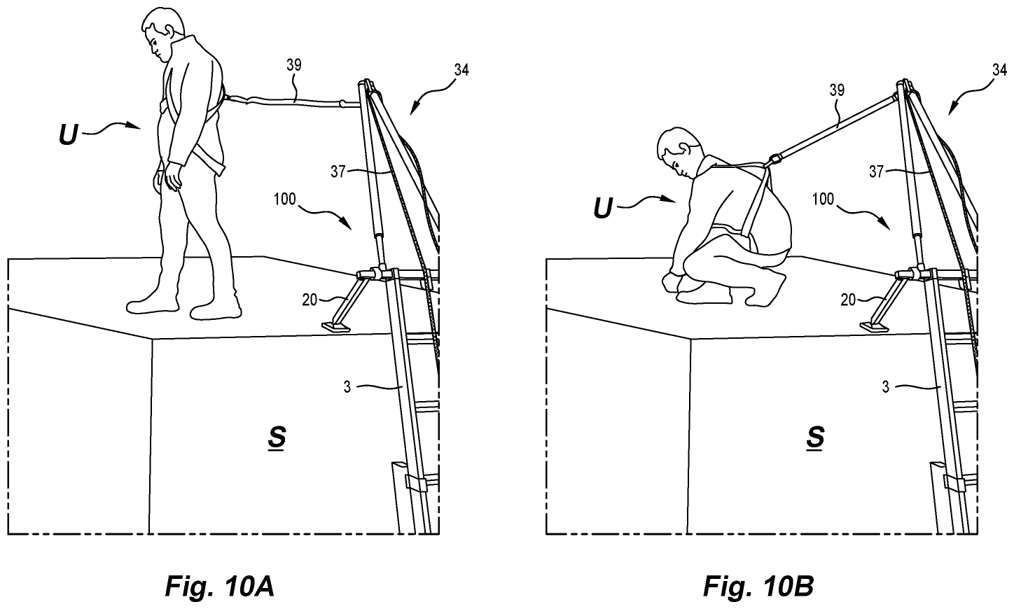

Each leg 20 comprises a proximal end coupled to the coupling device 1 and a distal end having a foot 21. The foot 21 is articulated via a universal joint, to allow the foot 21 to stabilise against a planar surface. The support surface S of FIG. 4A is vertical, while the support surface in FIG. 10A is horizontal. The foot 21 can also provide a pad 21a to increase friction between the foot 21 and the support structure S.

The leg 20 is mounted to the coupling device 1 via an adjustable connector 23. The connector 23 comprises three components: a first member or cuff 24 for attaching to the leg 20; a second member or collar, illustrated as ring connector 25 for attaching to the elongate support member 6; and a lock 26 for securing and releasing the cuff 24 to the leg 20.

The connecting cuff 24 is configured in an O-shape that wraps around the leg 20 of the utility module 60, such that it is translatable along the length of the leg 20. Alternatively, the connecting cuff 24 can have an open C-shaped section (not illustrated).

Each leg 20 provides a series of spaced apertures 22 therealong. The cuff 24 provides a single hole 24a for receiving the lock 26. The cuff 24 can partially or fully encircle the leg 20, such that when the cuff 24 is positioned along the leg 20, the lock 26 is engaged to secure the cuff 24 to a selected aperture 22 of the leg 20. The lock 26 can be a spring-loaded bolt or rod. The lock 26 can be selected to require tools to fix it in place, or a screw mechanism. However, some form of quick release lock 26 is preferable to eliminate the requirement for tooling.

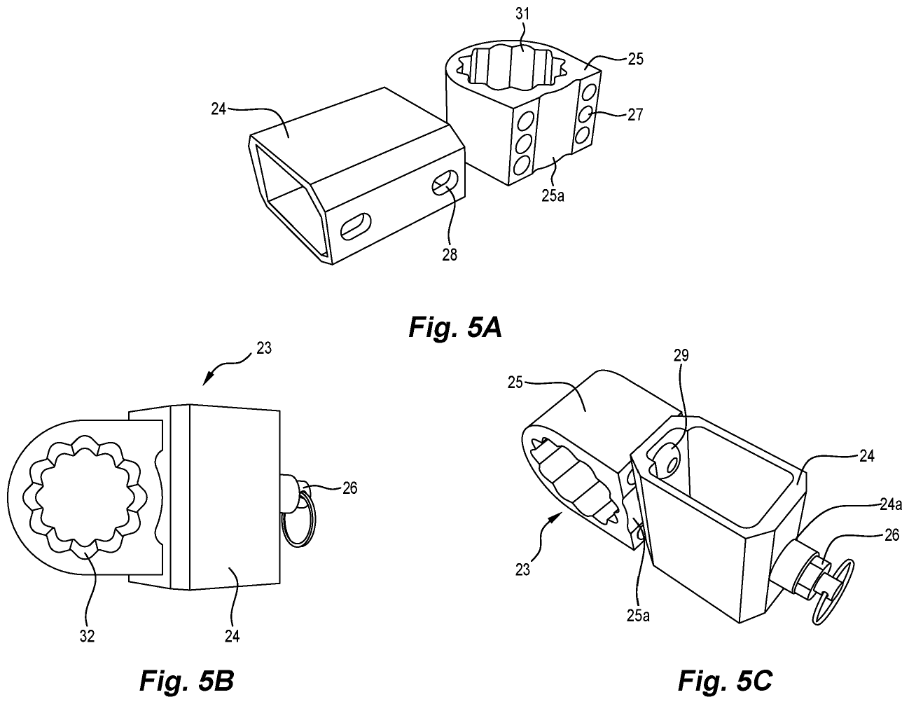

The cuff 24 has a cross-section similar in shape and size to a cross-section of the leg 20 and is shown in FIGS. 5A-5C to be substantially rectangular. On operational face of the cuff 24 houses the lock 26, and a second face of the cuff 24 is provided with a plurality of cuff fixing holes 28. In use, the second face of the cuff 24 shares a common plane with a mounting face 25a of the ring-connector 25. The mounting face 25a is provided with a plurality of fixing holes 27 for connecting the cuff 24 thereto in a variety of different orientations. FIG. 5C illustrates the cuff 24 and ring-connector 25 mounted to each other by a pair of bolts 29.

The ring-connector 25 has a central aperture 31 allowing the ring-connector 25 to be mounted over the elongate support member 6. Additionally, the central aperture 31 is internally splined to create a plurality of discrete mounting orientations to the ring-connector 25 when attached to the elongate support member 6. Illustrated in FIG. 5B, the splines 32 are oriented at 30-degree intervals around the central aperture 31, providing twelve discrete mounting orientations between the ring-connector 25 and the elongate support member 6, where the elongate support member 6 has a square cross-section.

The leg 20 is securely mounted in the cuff 24 via the lock 26. The cuff 24 is secured to the ring-connector 25 in a desired orientation via fixing holes 27, 28 and the ring-connector 25 is mounted to the elongate support member 6 in a first of the twelve available mounting angles. This arrangement is set-up on each side of the ladder 3, resulting in the vertical stand-off ladder assembly 100, as illustrated in FIG. 4A.

The adjustable connector 23 can be forged, cast, extruded or machined or a combination of the above. The adjustable connector 23 components can be made from metal, for example steel, aluminium or alloys thereof.

The articulating foot 21 is rectangular and connected to the leg 20 via the universal connector arrangement or similar ball and socket arrangement. The foot 21 can be made from a metal or rigid plastic material, whilst a rubber or elastomeric material forms the pad 21a to increase friction with support surface S.

### Second Utility Module 2: Davit Arm

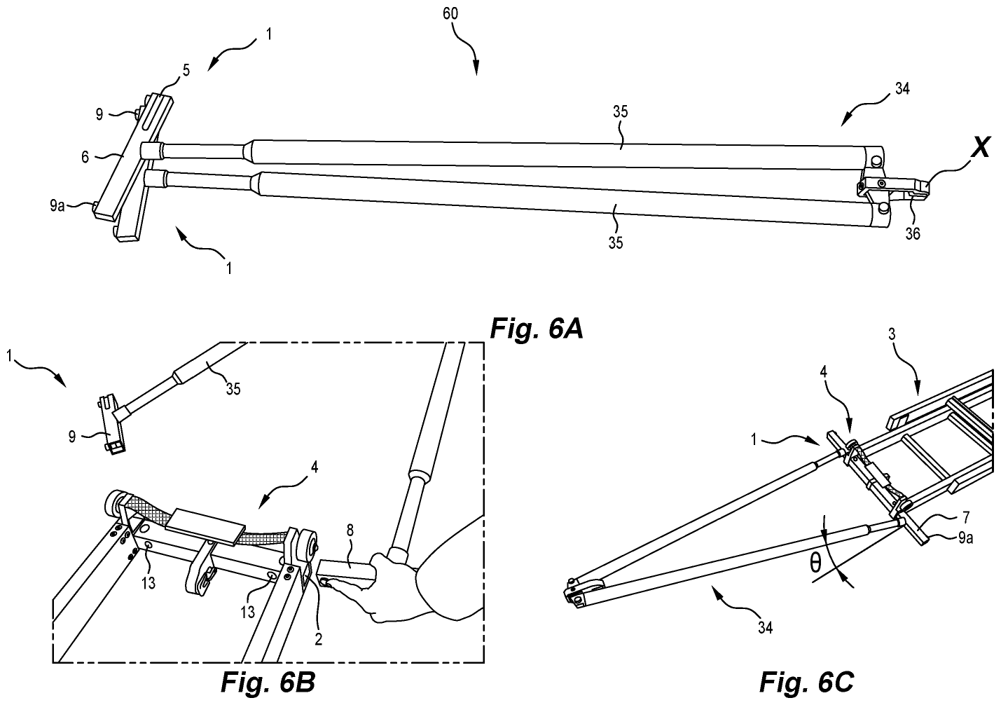

FIGS. 6A-6C illustrate a second utility module 60 comprising a counterbalance to the ladder assembly 100 in the form of an armature illustrated as davit arm 34, for counterbalancing the weight of a user on the ladder 3. The davit arm 34 utilises a pair of converging uprights 35 supporting the arrest rope 37 attached to a user, such that the weight of the user is applied to the ladder assembly 100 off axis to the ladder 3. This creates a moment about the ladder 3, there the user's weight is less likely to pull the ladder assembly 100 away from the support structure which it is mounted on.

The pair of uprights 35 are fixed together at a first convergent end forming an apex X. The free ends of each of the pair of uprights 35 is engaged with a coupling device 1. In some embodiments the pair of uprights 35 are releasably mounted to the coupling devices 1 or (as illustrated in FIG. 6A) the coupling device 1 is integrally formed into each of the pair of uprights 35.

The user inserts the mounting region 8 of each of the pair of uprights 35 into opposing bores 2 in the headstock 4 of the ladder 3. The detents 9 spring into position through apertures 13 locking the davit arm 34 into a fixed orientation with the ladder 3.

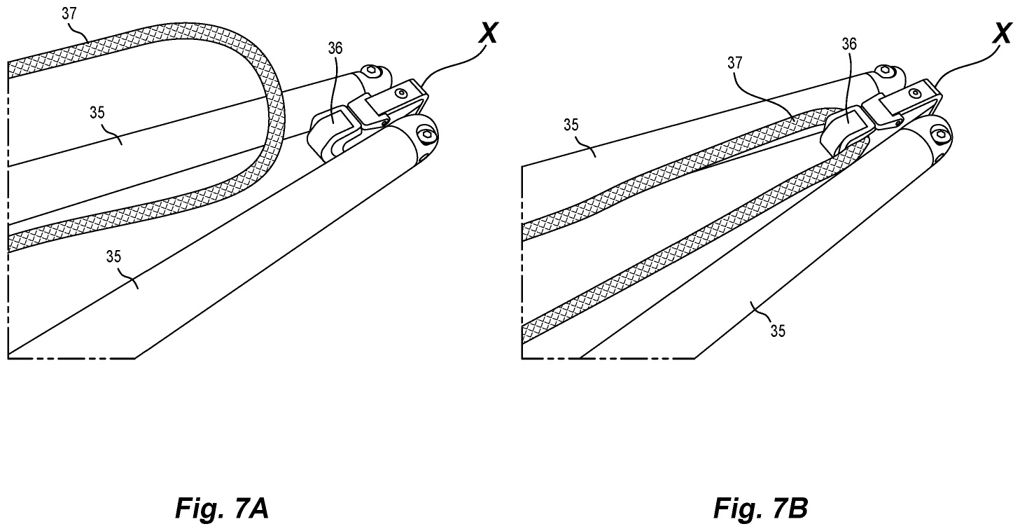

At the apex X of the davit arm 34 is a closable hook 36 for receiving and retaining the arrest rope 37 (see FIGS. 7A and 7B). The arrest rope 37 forms part of a fall control system which can be mounted to the ladder 3. A tethering aperture can be formed by the closable hook 36 to fix the davit arm 34 to a fixed structure S.

The closable hook 36 provides a smooth, upper guide for the arrest rope 37 to run through. A user, before ascending the ladder assembly 100 can tether themselves to the ladder assembly 100 via a harness or rope grip to the arrest rope 37. The harness can provide an acceptable length of travel for the user, for example 300 mm. Such that, in the event of a fall the user maintains connection with the ladder assembly 100 and is limited to only falling the 300 mm allowed.

An inclination angle ϕ of the uprights 35 with respect to the support structure S is thus determinative of the load transferred down the stiles 11 of the ladder 3, when the user's weight is applied to the closable hook 36 via the arrest rope 37. Furthermore, as shown in FIGS. 10A and 10B, a harness 39 can be attached to the apex X of the davit arm 34, providing an attachment point for the user at an elevated level whilst working at the elevated work zone.

As the user is ascending the ladder assembly 100, their weight is supported by their feet on the rungs on the ladder 3. On losing balance or losing footing, the user's weight is transferred onto the arrest rope 37, which mounts (and acts through) closable hook 36. The centre of mass of the user is then shifted to behind the ladder assembly 100, by virtue of the davit arm 34 which hangs over the support structure S at the inclined angle ϕ to the ladder 3. The user's weight is still transferred to the ladder 3 but the centre of gravity is not aligned with or worse, in front of, the ladder 3, so the load from the user on losing footing, will not urge the ladder assembly 100 off the support structure S.

This davit arm 34 arrangement is set-up on each side of the ladder 3, resulting in the counter-balance ladder assembly 100, as illustrated in FIG. 1B.

### Third Utility Module: Davit Arm with Supporting Legs

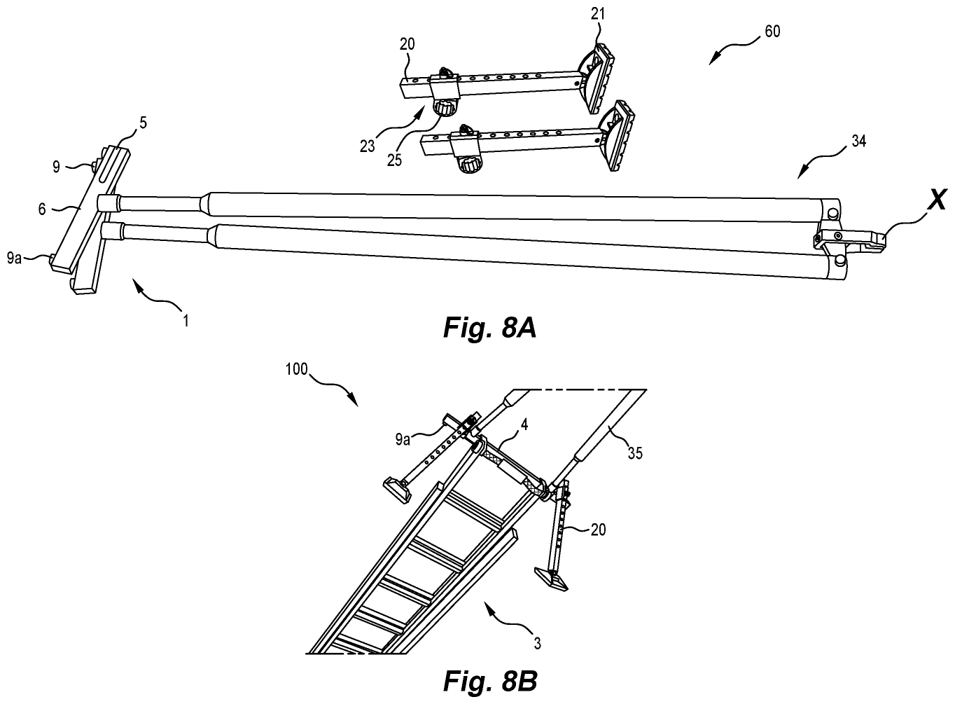

FIGS. 8A-8B illustrate a third utility module 60 comprising a combination of each of the first and second utility modules 60: the pair of supporting legs 20 with a davit arm 34.

FIG. 8A illustrates the components of the utility module 60, having a pair of legs 20 with non-slip feet 21. A pair of adjustable connectors 23 for mounting the legs 20. And a pair of converging uprights 35 having integrally formed coupling devices 1.

FIG. 8B illustrates the ladder assembly 100, with the ladder 3 having the third utility module 60 attached thereto. The utility module 60 is mounted and secured to the ladder 3 prior to erecting the ladder 3 against a support structure S.

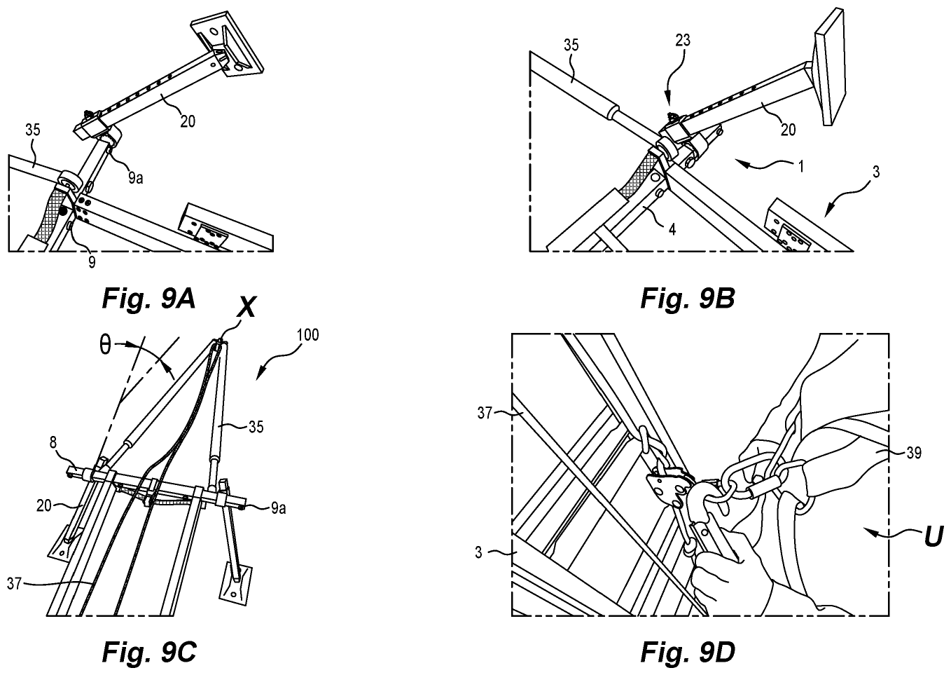

FIGS. 9A and 9B illustrate the legs 20 being slidably attached to the elongate support member 6 after the davit arm 34 is mounted to the headstock 4. The leg 20 is oriented by the adjustable connector 23 as described herein.

The adjustable connector 23 is slid along the elongate support member 6 at which time the secondary detent 9a is released into a corresponding aperture of the elongate support member 6 to secure the adjustable connector 23 therealong. Alternatively, the adjustable connecter 23 is slid along the elongate support member 6 and past the retracted secondary detent 9a. The secondary detent 9a is then released such that the adjustable connector 23 is then retained on the support member 6.

FIG. 9C illustrates the davit arm 34 and stand-off legs 20 and the arrest rope 37 all rigged to the ladder assembly 100 prior to being erected, this Figure also shows the inclination angle ϕ from which the user's weight is offset by the davit arm 34.

FIG. 9D is a user U, wearing a safety harness 39 attaching themselves to the arrest rope 37 by virtue of a rope grab.

FIGS. 10A and 10B, illustrate the user U at an elevated work zone, attached to the ladder assembly 100 via the harness 39. In some work zones, there may be no elevated anchor points or safety attachment points for a user U. In such a scenario, the user U can remain attached to the ladder assembly 100 via the harness 39 and continue to work within the range of the harness 39. Should the user U lose balance or footing, the ladder assembly 100 provides a safety anchor for the user U. Where the arrest rope 37 and davit arm 34 are used, it is also preferred that the ladder assembly 100 is tethered to a wall or the ground to provide the required stability for support the user in a “fall arrest” situation and for keeping the ladder assembly 100 in an upright orientation.

This davit arm 34 and support leg 20 arrangement is set-up on each side of the ladder 3, resulting in the counter-balance ladder assembly 100, as illustrated in FIG. 9C.

### Fourth Utility Module: Winch

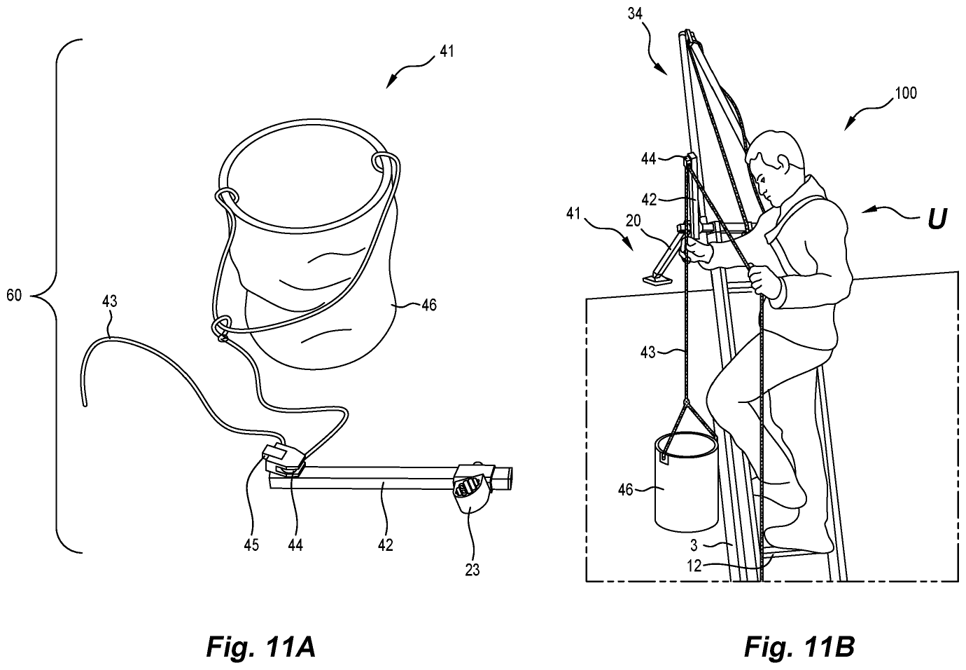

FIGS. 11A-11B illustrate a fourth utility module 60 comprising a winch 41 which may be used independently of other modules or alternatively in combination, for example in combination with the pair of supporting legs 20 of the first utility module and/or the davit arm 34 of the second utility module.

The winch 41 comprises a winch arm 42 for supporting a winch cable 43. The winch cable 43 is attached to a receptacle, shown in FIG. 11A as a cable store or collapsible bucket 46. The bucket 46 can also be used to store all components of the winch 41 for transport.

A first end of the winch arm 42 is provided with an adjustable connector 23 as described herein. This facilitates mounting of the winch arm 42 to the coupling device 1. The winch arm 42 can be mounted to the headstock 4 alone, or in combination with other utility modules 60, as shown in FIG. 11B.

A second distal end of the arm 42 is provided with a cable brake 44. The cable brake 44 receives the winch cable 43 therein and the winch cable 43 winds internally through the cable brake 44 to exit the cable brake 44. The cable brake 44 provides internal teeth (not illustrated) that grip the cable 43 allowing free movement of the cable 43 through the brake 44 in a first direction only. This allows the user U to pull on the cable 43 to raise the bucket 46 towards the elevated work zone without the need to tie the cable 43 off. The user U can then operate the winch 41 with only one hand, leaving a second hand free to stabilise their position on the ladder assembly 100.

The cable brake 44 can also provide a cable release 45, such that a user U can selectively deactivate the brake 44, allowing the bucket 46 to return towards a base of the ladder assembly 100. The winch cable 43 can be a chain, a cable, a rope or a twisted rope. The cable 43 can be selected for its weight bearing properties to suit the load to be raised in the bucket 46. The cable 43 can be a similar material to the arrest rope 37 used to secure the user U to the ladder assembly 100.

A davit arm 34 and support leg 20 arrangement is set-up on each side of the ladder 3, having a winch 41 on a first side of the ladder 3 as illustrated in FIG. 11B.

### Fifth Utility Module Pole Tether

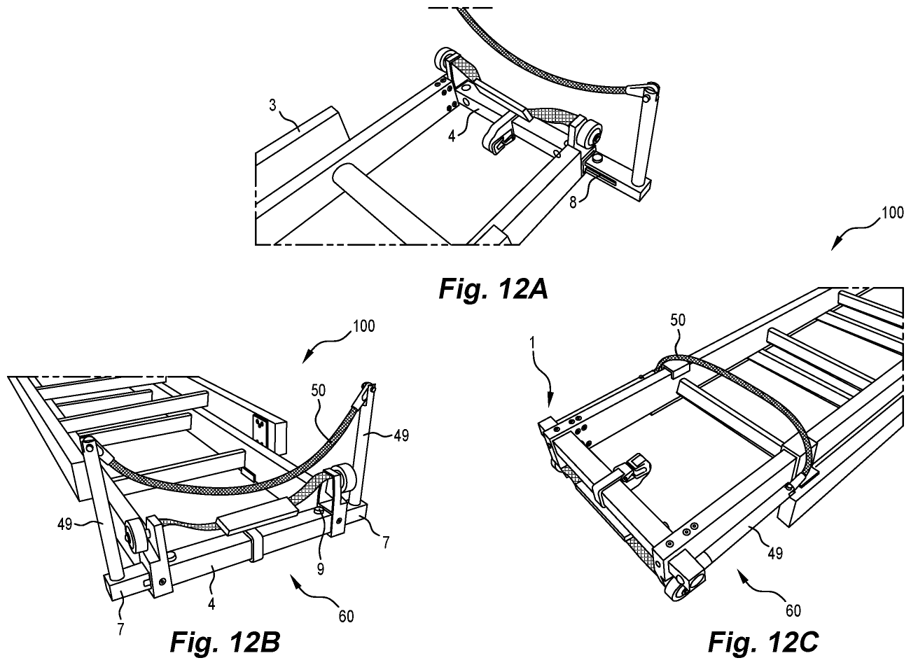

FIGS. 12A-12C illustrate a fifth utility module 60 comprising a pole tether assembly 48. The pole tether assembly can be employed to prevent the ladder assembly 100 from slipping off a supporting pole, for example a utility pole. Particularly in the event of a user losing their footing, falling from the ladder, or pulling the ladder off the support pole.

Once at the elevated working zone atop a ladder 3 it is easy for a user U to become complacent or forget that they are elevated and to then overextend themselves. This overextension also happens where people decide not to reposition the ladder 3 but to stretch a little further.

To better support a user U and to stabilise the top of the ladder assembly 100, the pole tether assembly 48 is provided for mounting the ladder 3 to the pole for example a telegraph/utility pole or lamp post (not illustrated).

The ladder assembly 100 is erected against the supporting pole, and the pole tether assembly 48 is then affixed around the pole to tether the ladder assembly 100 against the load of the user stretching away from the ladder 3 (and the ladder's centre of gravity).

The pole tether assembly 48 comprises a pair of extending arms 49 supporting a flexible member or cable 50 therebetween. A first end of each arm 49 is engaged with a coupling device 1 to be removably inserted into the bore 2 of the headstock 4. A second end of each arm, distal to the ladder is connected to the cable 50. This arrangement provides a closed loop to the pole tether assembly 48 formed partially by the headstock 4 of the ladder assembly 100 and partially by the cable 50.

The user can affix a portion of the pole tether assembly 48, for example a first of the extending arms 49 to a first bore 2 of the headstock 4, prior to erecting the ladder assembly 100. As the user U ascends the ladder assembly 100, the user encircles the support pole with the cable 50 and then inserts a second of the extending arms 49 into a second bore 2 at the opposing side of the headstock 4, using the detents 9 to secure the extending arms of the coupling device 1 to the ladder 3. This results in the cable 50 tethering the ladder assembly 100 to the supporting pole.

The cable 50 can be a thick belt or a rope, or a chain. The cable 50 can be permanently affixed to the extending arms 49 or can be fitted with a releasable connection such as a carabiner or a buckle to allow a user to selectively disengage the pole tether assembly 48 from atop the ladder assembly 100.

A pole tether assembly 48 is set-up to extend between the two stiles of the ladder 3, as illustrated in FIG. 12B.

### Sixth Utility Module: Extension Rails

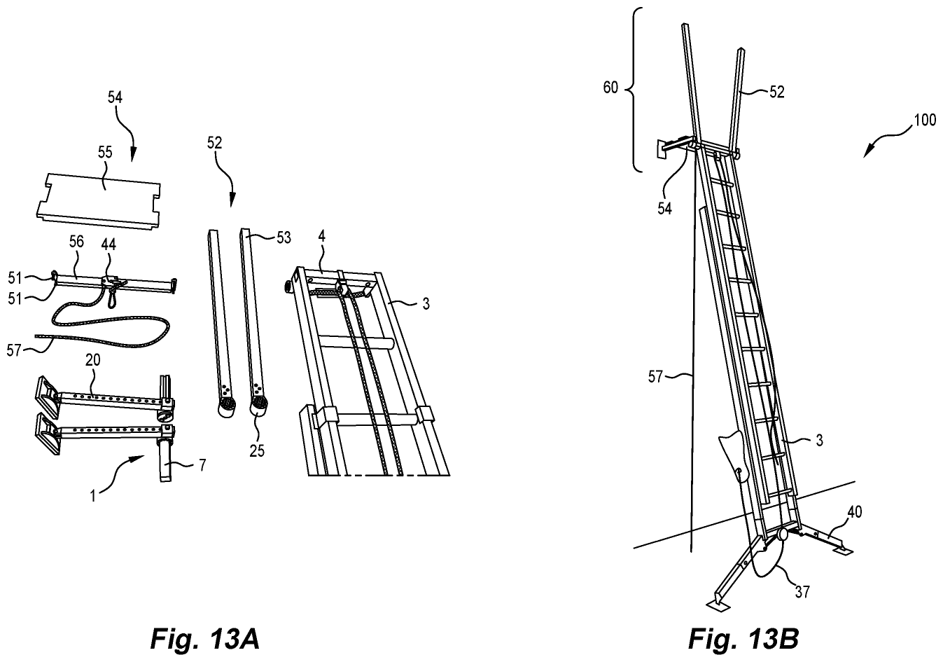

FIGS. 13A-13B illustrate a sixth utility module 60 comprising a safety rail assembly 52.

The safety rail assembly 52 comprises a pair of hand rails 53 that can be mounted to the ladder 3 via the coupling device 1 to provide hand rails to the top of the ladder assembly 100 to provide improved safety to a user when transitioning between the ladder assembly 100 and the elevated working zone.

Each hand rail 53 is configured for a purpose, in FIG. 13A the hand rails 53 are straight sections having a peripheral length suitable for gripping by a user. In some embodiments, the rails 53 can be curved or shaped to provide arm rests or rounded handle or grip supports. Each of the hand rails 53 is provided with a ring-connector 25 affixed thereto. The ring-connector 25 can be formed separately to the hand rail 53 or integrally therewith.

The hand rails 53 can be mounted to the coupling device 1 at twelve discrete orientations by virtue of the internal splines 32 as described herein.

The hand rails 53 can be mounted to the elongate support member 6 of the coupling device 1 directly, as illustrated in FIG. 13B, along with the support legs 20. In some embodiments, the hand rails 53 can instead be mounted to the support legs 20 combining the vertical stand-off utility module with this safety rail assembly 52.

The hand rails 53 can be formed of metal, such as steel or aluminium. Alternatively, the hand rails 53 can be formed of plastics, polymers or composite combinations of the aforementioned.

A safety rail assembly 52 is set-up to extend between the two stiles of the ladder 3, as illustrated in FIG. 13B.

### Seventh Utility Module: Horizontal Platform

FIGS. 13A-13B further illustrate a seventh utility module 60 comprising a work platform assembly 54.

The work platform assembly 54 comprises a work platform 55, a cross-beam 56, a cable brake 44 and a hoist cable 57.

The platform 55 can be planar and can further comprise raised edges to help keep tools and components on the platform 55. The platform 55 can function as a work bench at the elevated working zone, providing a flat surface to assemble and disassemble components or to cut and splice cables etc. In some embodiments the platform 55 can be sufficiently strong to support the weight of the user and provide a working platform for the user and not merely their tools.

The platform 55 is mounted to the headstock 4 via the legs 20 of the first utility module 60. The legs 20 are mounted to the headstock 4 via the coupling device 1 at a 90 degree (or greater angle) such that the platform 55 is horizontally supported on the ladder assembly 100. The cross-beam 56 is also supported on the legs 20 and is configured to align and connect with two of the plurality of apertures 22 of the legs 20, one on each side of the platform 55. The cross-beam 56 can be provided with at least one protrusion or pin 51 at opposing ends thereof, which are received into the apertures 22 of the legs 20, where gravity will hold the cross-beam 56 in position under the weight of the platform 55 and any tools thereon.

Shown in FIG. 13A, the cross-beam 56 further supports a hoist cable 57 run through a cable brake 44. The cable brake 44 is the same as that described earlier in this specification, simply mounted at a different orientation so as to maintain access to the cable release 45 under the work platform 55.

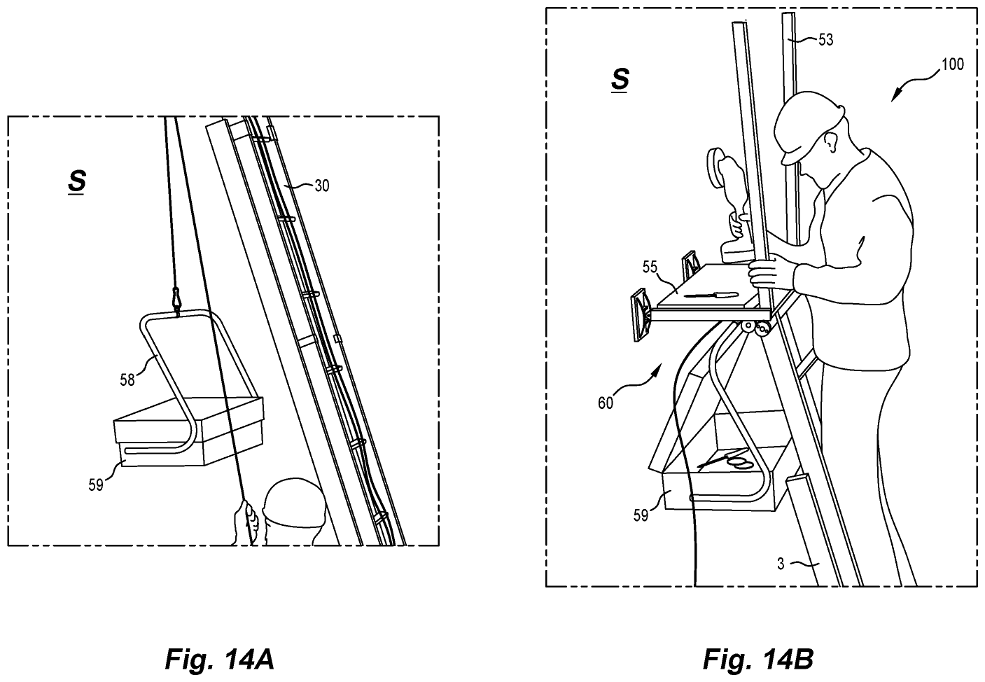

This allows tools and tool boxes to be hoisted up to the work platform 55 adjacent the elevated work zone (see FIG. 14A and 14B). A mounting bracket 58 configured to right a tool kit 59, mounted to the bracket, is illustrated in FIGS. 14A-14B allowing the user to remain a top the ladder assembly 100 and have full access to the required tools. This reduces the number of trips up and down the ladder assembly that the user is required to make, and also eliminates the need for the user to ascend the ladder with occupied hands.

### Eighth Utility Module

An eighth utility module is shown in FIGS. 13B and 14B, where the safety rail assembly as described above is used in combination with the support legs and the work platform assembly 54.

It will be appreciated by persons skilled in the art that numerous variations and modifications may be made to the above-described embodiments, without departing from the scope of the following claims. The present embodiments are, therefore, to be considered in all respects as illustrative and not restrictive.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### LEGEND

| Ref# | Description | Ref# | Description |
|---|---|---|---|
| 100 | Ladder Assy | 36 | Closable hook |
| 1 | Coupling device | 37 | Arrest rope |
| 2 | bore | 38 | Tether aperture |
| 3 | ladder | 39 | Harness |
| 4 | headstock | 40 | Stabilising base |
| 5 | spline | 41 | Winch |
| 6 | Elongate support member | 42 | Winch arm |
| 7 | Mounting region | 43 | Winch cable |
| 8 | Working region | 44 | Cable brake |
| 9 | detent | 45 | Cable release |
| 10 | Support section | 46 | Cable store |
| 11 | Stile | 48 | Pole tether Assy |
| 12 | rung | 49 | Extending arms |
| 13 | Aperture | 50 | Flexible cable |
| 20 | Support leg | 51 | Cross-beam pin |
| 21 | Feet | 52 | Safety rail assy |
| 22 | Apertures of leg | 53 | Hand rails |
| 23 | Adjustable connector | 54 | Work platform assy |
| 24 | Cuff | 55 | Work platform |
| 25 | Ring connector | 56 | Cross-beam |
| 26 | Lock | 57 | Hoist cable |
| 27 | Ring-connector fixing holes | 58 | Mounting bracket |
| 28 | Cuff fixing holes | 59 | Tool kit |
| 29 | Bolt | 60 | Utility module |
| 30 | Movable section | | |
| 31 | Central aperture to ring connector | | |
| 32 | splines | X | Apex |
| 34 | Davit arm | U | User |
| 35 | Uprights | S | Supporting structure |
| | | Ø | Inclination angle of |
| | | | armature |

1-40. (canceled)

41. A coupling device, for a ladder having a bore extending between a pair of spaced apart styles, the coupling device comprising:
an elongate support member having a mounting region and a working region, the mounting region configured to be received within the bore of the ladder to engage therewith, and the working region being configured to protrude from the bore and to receive and support one or a plurality of utility modules; and
a releasable detent to secure the elongate support member within the bore, wherein the mounting region is restrained from rotational movement relative to the bore, and the releasable detent prevents longitudinal movement of the elongate support member relative to the bore.

42. The coupling device of claim 41, wherein the mounting region is restrained from rotation by the cross-sectional geometry of the elongate support member.

43. The coupling device of claim 41, wherein each of the bore and the elongate support member have a square cross-section.

44. The coupling device of claim 41, wherein the elongate support member comprises two parts, a first portion and separate a second portion, each portion configured to provide a mounting region and a working region, such that the working regions of each of the first portion and the second portion protrude from the bore with the mounting regions received within opposing ends of the bore of the ladder.

45. The coupling device of claim 41, wherein the elongate support member comprises a single beam having the mounting region centrally located along the beam and working regions located at opposing ends of the beam, such that the working regions protrude from the bore of the ladder when the elongate support member is mounted thereto.

46. The coupling device of claim 44, wherein the mounting region of the or each elongate support member is axially splined to prevent rotation relative to the bore, and/or the working end of the or each elongate support member is splined or keyed to receive a non-rotatable connector thereabouts.

47. The coupling device of claim 46, wherein the bore is internally splined to receive the axial splines of the elongate support member and thereby prevent rotational movement therebetween.

48. The coupling device of claim 47, wherein the detent is selected from the following group: a bolt, a pin, a spring-loaded stopper, a bolt spring plunger and a snap-lock plunger.

49. A ladder assembly comprising the coupling device of claim 41, in combination with a first of the plurality of utility modules, wherein the first of the plurality of utility modules comprises a pair of adjustable legs for supporting the ladder on a vertical or a horizontal surface.

50. The ladder assembly of claim 49, wherein each leg comprises a plurality of equidistantly spaced holes for releasably engaging an adjustable connector,
the adjustable connector comprising two pieces: a connecting cuff and a releasable collar, the cuff at least partially encircling the leg and providing a locking means to releasably secure the cuff to one of the plurality of holes along the leg.

51. A ladder assembly comprising the coupling device of claim 41, in combination with a second of the plurality of utility modules, wherein the second module comprises an armature for counterbalancing the weight of a user on the ladder and stabilising the ladder.

52. The ladder assembly of claim 51, wherein the armature is configured as a davit arm, comprising two converging uprights attached to the elongate support member.

53. The ladder assembly of claim 52, wherein converging ends of the two converging uprights are constrained to one another at an apex which provides a closable mount, and wherein the closable mount is configured to receive and retain a static line or an arrest rope therein, the arrest rope being attached directly or indirectly to a user ascending the ladder.

54. A ladder assembly comprising the coupling device of claim 41 in combination with a fourth of the plurality of utility modules, wherein the fourth module comprises a winch system for winching items to an upper working level of the ladder.

55. The ladder assembly of claim 54, wherein the winch system comprises a winching arm, having a first end and a second end, the first end of the winching arm being mountable to the elongate support member via a cuff and collar.

56. A ladder assembly comprising the coupling device of claim 41, in combination with a fifth of the plurality of utility modules, wherein the fifth module comprises a pole tether for securing a user to a top portion of the ladder to provide hand-free working, and wherein the pole tether is mounted to the coupling device by a pair of side arms, the side arms being connected to the first and second portions of the elongate support member, and wherein the side arms extend outwardly from both the bore of the ladder and from the styles of the ladder.

57. The ladder assembly of claim 56, wherein the two side arms are interconnected by the pole tether, and wherein the pole tether is a flexible member that is arcuate, to allow the flexible member in combination with the ladder to encircle a cylindrical tether structure.

58. A ladder assembly comprising the coupling device of claim 41, in combination with a sixth of the plurality of utility modules, wherein the sixth module comprises a pair of adjustable rails for assisting a user transitioning from the ladder to an elevated working zone, the pair of adjustable rails each comprise an internally splined collar to engage with the elongate support member at any one of twelve discrete mounting orientations.

59. A ladder assembly comprising the coupling device of claim 41, in combination with a seventh of the plurality of utility modules, wherein the seventh module comprises a horizontal platform for supporting a user at the top of the ladder or providing a horizontal working surface at the top of the ladder.

60. A kit comprising the coupling device according to claim 41, and a headstock for a ladder, the headstock having a bore extending at least partially therethrough for receiving the elongate support member of the coupling device.
